(19) United States
(12) Patent Application Publication
(10) Pub. No.: US 2009/0057520 A1
(43) Pub. Date: Mar. 5, 2009

(54) Displacement Platform with a Precision Plane

(76) Inventors: Makoto Tada, Hatogaya-shi (JP); Chi-Pin Chou, Taichung (TW); Li-Shua Sun, Taichung (TW)

Correspondence Address: Dr. BANGER SHIA, 102 Lindencrest Ct., Sugar Land, TX, 77479-5201, US

(21) Appl. No.: 11/850,567

(22) Filed: Sep. 5, 2007

(51) Int. Cl. F16M 13/00; F16M 11/00

(52) U.S. Cl. 248/419; 248/157

(57) ABSTRACT

A displacement platform with a precision plane is a platform structure which comprises a base, a platform, a displacement device and two thrust bearing assemblies. The displacement device and the thrust bearing assemblies are disposed between the base and the platform. The thrust bearing assemblies are moved left and right. The platform cooperates with the displacement device to adjust the predetermined pressure and the height, such that the platform structure not only has the characteristic of high pressure resistant, but also can adjust the height and the left and right moving positions.

### BACKGROUND OF TIRE INVENTION

1. Field of the Invention

The present invention relates to a displacement platform with a precision plane, and more particularly to a displacement platform with a precision plane which not only has the characteristic of high pressure resistant, but also can adjust the height and the left and right moving positions by the thrust bearing assemblies and the platform.

2. Description of the Prior Art

A displacement platform device with a universal joint shaft is disclosed in TW Pat. serial number 093138167, which provides a working platform to adjust the base and the parallel degree when the upper and lower moulds of the mold-pressing mechanism are pressed. An angle-adjustable thrust bearing is mounted on a positioning base, an upper seat of the thrust bearing is connected to the working platform, such that the working platform has three degrees of freedom, namely two translational degrees of freedom and a rotational degree of freedom. Moreover, between the positioning base and the working platform is disposed three sets of connecting rod assemblies, and each connecting rod assembly has two pairs of universal joints. A sliding rod is fixed in the bottom of each connecting rod assembly by a locking mechanism and can slide up and down.

However, the above-mentioned device still has the following disadvantages:

Firstly, the angle-adjustable thrust bearing is mounted on the positioning base that is superposed on the upper and lower moulds of the mold-pressing mechanism, and the upper seat of the thrust bearing is superposedly connected to the working platform, such a superposed structure is very complex.

Secondly, the angle-adjustable thrust bearing is mounted on the positioning base, the upper seat of the thrust bearing is connected to the working platform, such that the working platform has three degrees of freedom, namely two translational degrees of freedom and a rotational degree of freedom. Such arrangements would lead to an excessively great moving strength or rotating strength and cause the deformation or even disassembly of the structure, which may hurts the user. Thereby, the above-mentioned device is insecure.

Thirdly, the positioning seat is disposed with one angle-adjustable thrust bearing, and the pressure resistant and tension resistant of such a single thrust bearing are too small, when in use, the mold-pressing machine is unstable since it cannot bear high pressure resistant and tension resistant.

The present invention has arisen to mitigate and/or obviate the afore-described disadvantages.

### SUMMARY OF THE INVENTION

The primary objective of the present invention is to provide a displacement platform with a precision plane which not only has the characteristic of high pressure resistant, but also can adjust the height and the left and right moving positions.

To achieve the objective of the present invention, the displacement platform with a precision plane is a platform structure which comprises a base, a platform, a displacement device and two thrust bearing assemblies. The displacement device and the thrust bearing assemblies are disposed between the base and the platform. The thrust bearing assemblies are disposed at both inner end surfaces of the displacement device and are abutted against one end surface of the base and the platform, respectively. The thrust bearing assemblies are moved left and right. The platform cooperates with the displacement device to adjust the predetermined pressure and the height, such that the platform structure not only has the characteristic of high pressure resistant, but also can adjust the height and the left and right moving positions.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a partial perspective view of a displacement platform with a precision plane in accordance with the present invention;

FIG. 2 is a top view of the displacement platform with a precision plane in accordance with the present invention;

FIG. 3 is a cross sectional view of FIG. 2 taken along the line 3-3;

FIG. 4 is another cross sectional view of FIG. 2 taken along the line 4-4; and

FIG. 5 is an illustrative view showing the operation of pressure resistant and tension resistant.

### DETAILED DESCRIPTION OF THE PREFERRED EMBODIMENTS

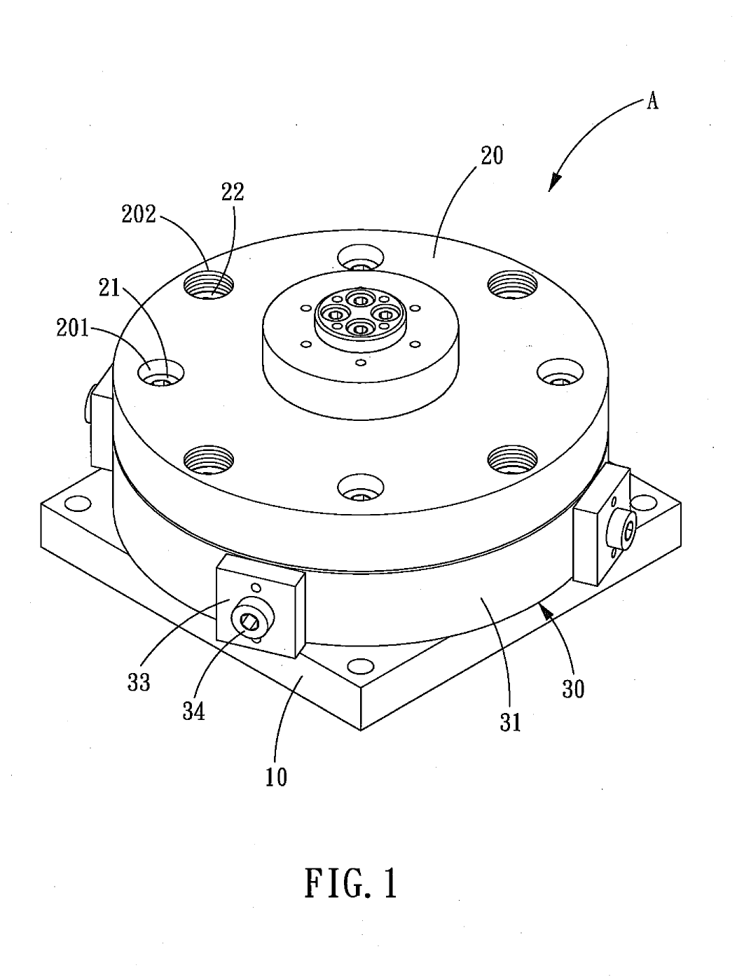

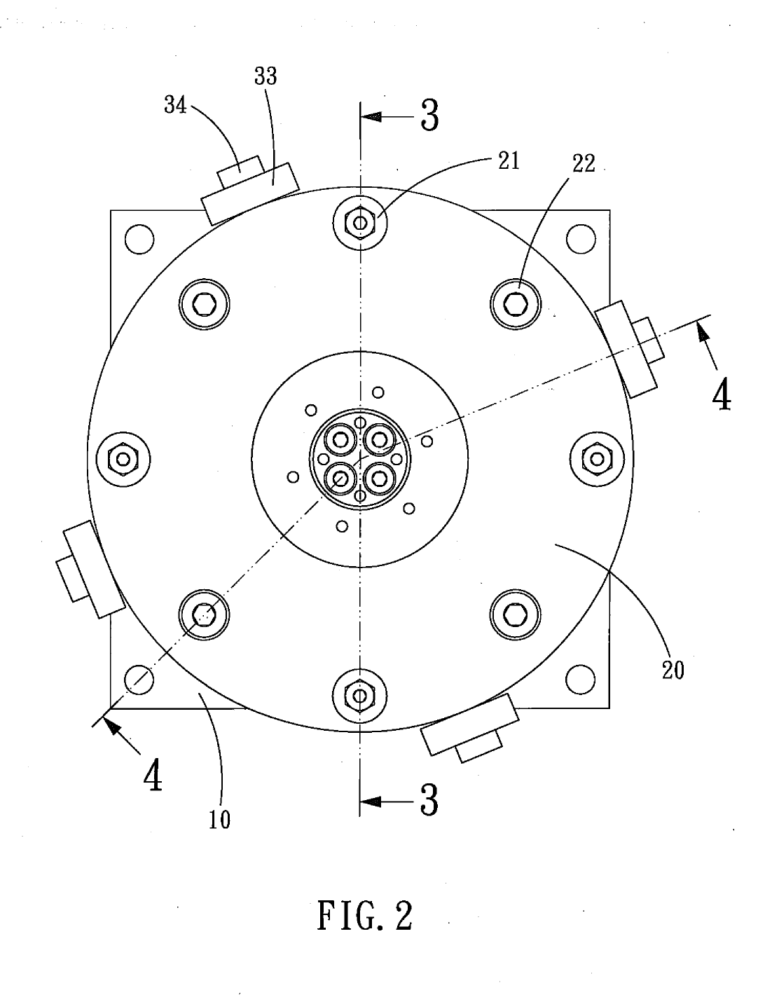

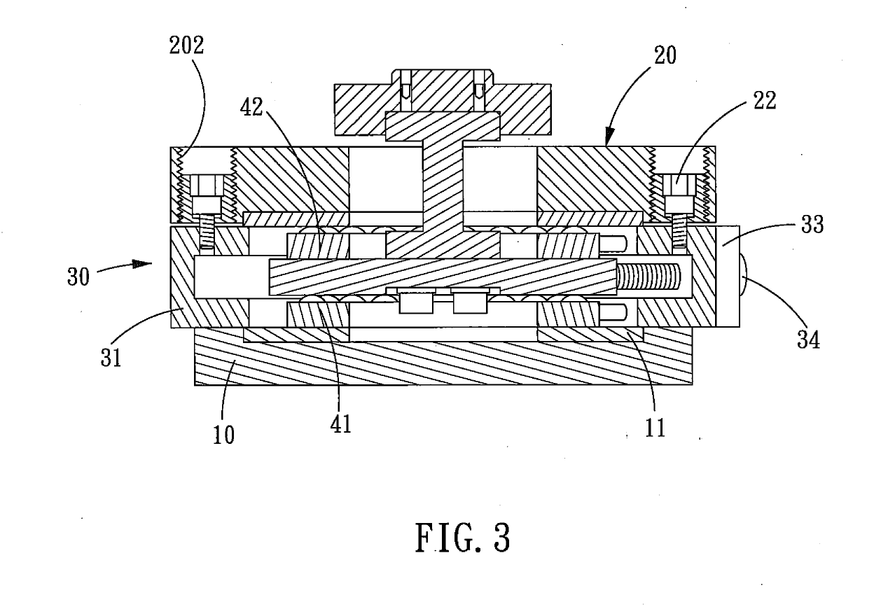

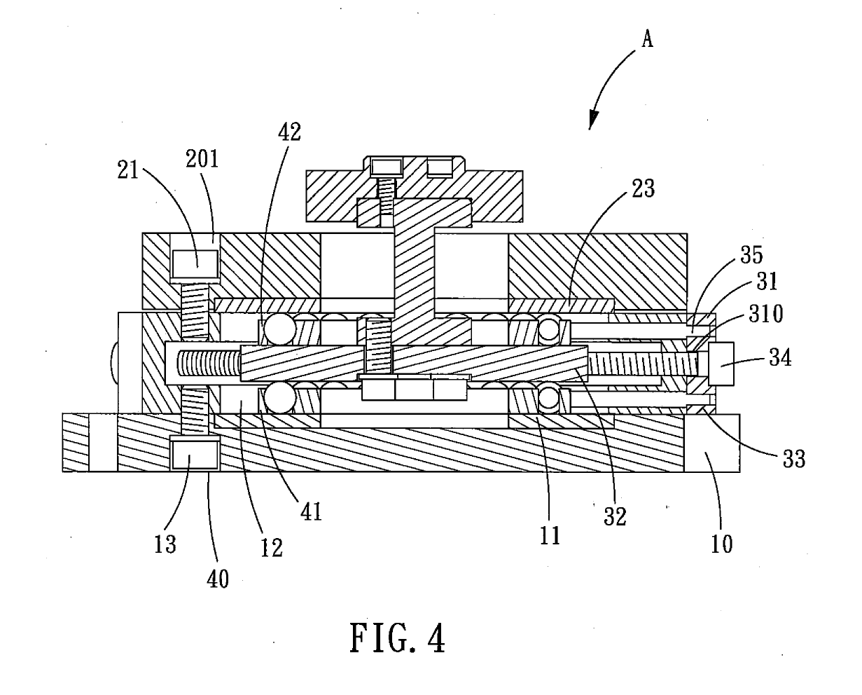

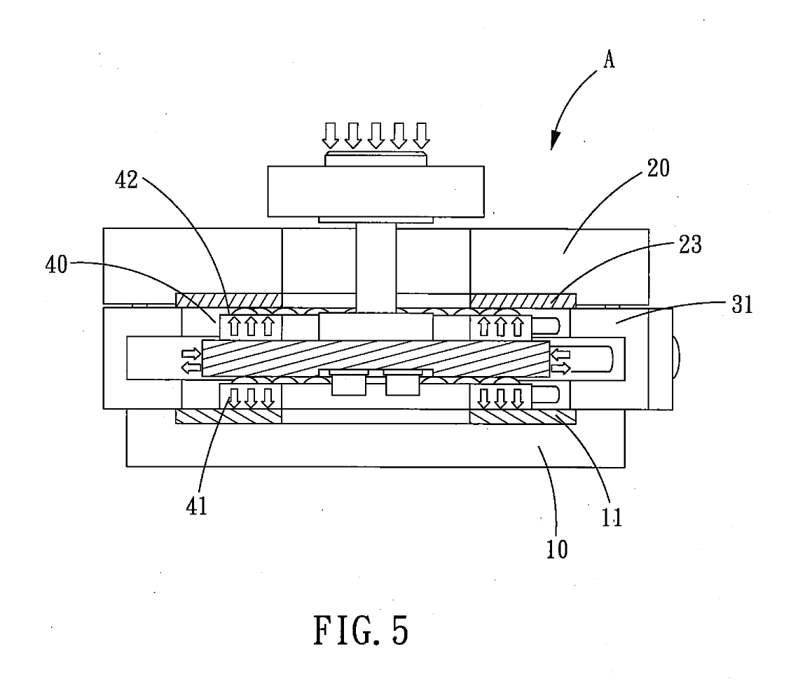

Referring to FIGS. 1-5, a displacement platform with a precision plane in accordance with the present invention is a platform structure A which comprises a base 10, a platform 20, a displacement device 30 and two thrust bearing assemblies 40. The displacement device 30 and the thrust bearing assemblies 40 are disposed between the base 10 and the platform 20. The thrust bearing assemblies 40 are disposed at both inner end surfaces of the displacement device 30 and are abutted against one end surface of the base 10 and the platform 20, respectively. The thrust bearing assemblies 40 are moved left and right. The platform 20 and the displacement device 30 are provided for adjusting the predetermined pressure and the height, such that the platform structure A not only has the characteristic of high pressure resistant, but also can adjust the height and the left and right moving positions.

The base 10 is square-shaped and includes a disk-shaped first abrasion proof portion 11, four penetrated portions 12 and four fasteners 13 in the form of T-shaped screws. The first abrasion proof portion 11 is located at one end surface of the base 10 close to the displacement device 30 and is abutted against one of the thrust bearing assemblies 40. The structure of the penetrated portions 12 is the same as that of the displacement device 30, and the penetrated portions 12 are provided for insertion of the fasteners 13.

The platform 20 is disk-shaped and includes four T-shaped locking members 21, four adjusting members 22 with threads, a disk-shaped second abrasion proof portion 23, four penetrated containing portions 201 and four adjusting portions 202 with threads thereof. The containing portions 201 are located correspondingly to the displacement device 30, and the locking members 21 are locked in the displacement device 30 after passing through the containing portions 201. The structure of the adjusting portions 202 is the same as that of the displacement device 30, and the adjusting members 22 are abutted against the displacement device 30 after passing through the adjusting portions 202. In addition, the second abrasion proof portion 23 is located at one end surface of the platform 20 close to the displacement device 30 and is abutted against the other bearing assembly 40.

The displacement device 30 includes a restriction member 31 in the shape of a hollow cylinder, a disk-shaped pressure resistant member 32, four square-shaped cushion members 33, four positioning members 34 in the form of T-shaped screws and eight column-shaped abutting members 35. The restriction member 31 is mounted between the base 10 and the platform 20 and is formed with four fixing portions 310 in the form of threaded holes that are located correspondingly to the penetrated portions 12 of the base 10 and the containing portions 201 of the platform 20. And the fixing portions 310 are locked by the fasteners 13 of the base 10 and the locking members 21 of the platform 20. One end surface of the restriction member 31 opposite to the platform 20 is abutted against the adjusting members 22. The pressure resistant member 32 is disposed in the center of the restriction member 31, and the thrust bearing assemblies 40 are mounted on both end surfaces of the pressure resistant member 32, respectively. In addition, the cushion members 33 are equidistantly disposed in an outer periphery of the restriction member 31, the positioning member 34 is threaded in the center of each cushion member 33, and two abutting members 35 are disposed at the upper and lower ends of each cushion member 33 close to each positioning member 34.

Each thrust bearing assemblies 40 includes a first bearing member 41 and a second bearing member 42. The first bearing member 41 is disposed at one end of the first abrasion proof portion 11 of the base 10 and the pressure resistant member 32, and the second bearing member 42 is disposed at the second abrasion proof portion 23 of the platform 20.

Referring to FIGS. 1-5 again, the first bearing member 41 is abutted against one end of the first abrasion proof portion 11 of the base 10 and the pressure resistant member 32, and the second bearing member 42 is abutted against the second abrasion proof portion 23 of the platform 20, such that the pressure resistant and tension resistant performance of the platform structure A is doubled. The locking members 21 locked in the containing portions 201 of the platform 20 and the adjusting members 22 threaded in the adjusting portions 202 are provided for adjusting the whole height of the platform structure A and eliminating the back clearances produced by the thrust bearing assemblies 40. Such arrangements not only can double the pressure resistant and tension resistant performance of the platform structure A, but also can adjust the height and eliminate the back clearances produced by the thrust bearing assemblies 40.

It is apparent from the above-mentioned descriptions that the present invention has the advantages described as follows:

Firstly, the first bearing member 41 of the bearing assembly 40 of the platform structure A is abutted against one end of the first abrasion proof portion 11 of the base 10 and the pressure resistant member 32, and the second bearing member 42 is abutted against the second abrasion proof portion 23 of the platform 20, such that the bearing members of each bearing assembly is jointed in a two layer type. Thereby, the structure of the platform structure A of the present invention is simplified.

Secondly, the first bearing member 41 of the bearing assembly 40 of the platform structure A is abutted against one end of the first abrasion proof portion 11 of the base 10 and the pressure resistant member 32, and the second bearing member 42 is abutted against the second abrasion proof portion 23 of the platform 20, such that the bearing members are jointed in the two layer type. Thereby, the pressure resistant and tension resistant performance of the platform structure A is doubled.

Thirdly, the locking members 21 locked in the containing portions 201 of the platform 20 and the adjusting members 22 threaded in the adjusting portions 202 are provided for adjusting the whole horizontal degree of the platform structure A and eliminating the back clearances produced by the thrust bearing assemblies 40. Thereby, the platform structure A can adjust the height and eliminate the back clearances produced by the thrust bearing assemblies 40.

While we have shown and described various embodiments in accordance with the present invention, it should be clear to those skilled in the art that further embodiments may be made without departing from the scope of the present invention.

What is claimed is:

1. A displacement platform with a precision plane, comprising:
a base formed with a first abrasion proof portion in one end surface thereof;
a platform formed with a second abrasion proof portion located correspondingly to the first abrasion proof portion;
a displacement device having a restriction member disposed between the base and the platform, and an pressure resistant member disposed in a center of the restriction member;
two thrust bearing assemblies, each of the thrust bearing assemblies including a first bearing member and a second bearing member, the first bearing member being disposed at one end of the first abrasion proof portion of the base and the pressure resistant member, the second bearing member being disposed at the second abrasion proof portion of the platform.

2. The displacement platform with a precision plane as claimed in claim 1, wherein the base includes the first abrasion proof portion, at least four penetrated portions and four fasteners, the first abrasion proof portion is located at one end surface of the base close to the displacement device and is abutted against the first bearing member, structure of the penetrated portions is the same as that of the displacement device, and the penetrated portions are provided for insertion of the fasteners.

3. The displacement platform with a precision plane as claimed in claim 1, wherein the platform includes at least four locking members, four adjusting members, a second abrasion proof portion, four containing portions and four adjusting portions, the containing portions are located correspondingly to the displacement device, the locking members are locked in the displacement device after passing through the containing portions, structure of the adjusting portions is the same as that of the displacement device, the adjusting members are abutted against the displacement device after passing through the adjusting portions, and the second abrasion proof portion is located at one end surface of the platform close to the displacement device and is abutted against the second bearing member.

4. The displacement platform with a precision plane as claimed in claim 1, wherein the displacement device includes a restriction member, an pressure resistant member, a plurality of cushion members, a plurality of positioning members and at least four abutting members, the restriction member is mounted between the base and the platform and is formed with a plurality of fixing portions that are located correspondingly to the penetrated portions of the base and the containing portions of the platform, the fixing portions are locked by the fasteners of the base and the locking members of the platform, one end surface of the restriction member opposite to the platform is abutted against the adjusting members, the pressure resistant member is disposed in a center of the restriction member, the thrust bearing assemblies are mounted on both end surfaces of the pressure resistant member, respectively, the cushion members are equidistantly disposed in an outer periphery of the restriction member, the positioning member is threaded in the center of each cushion member, and two abutting members are disposed at an upper end and a lower end of each cushion member of each positioning member.
